(19) United States
(12) Patent Application Publication
(10) Pub. No.: US 2020/0363840 A1
(43) Pub. Date: Nov. 19, 2020

(54) Magnetic Keyboard Protective Device Covering

(71) Applicant: NewFlux, LLC, Centerville, UT (US)

(72) Inventor: Jared Hurst, Centerville, UT (US)

(21) Appl. No.: 16/877,301

(22) Filed: May 18, 2020

Related U.S. Application Data
(60) Provisional application No. 62/849,153, filed on May 17, 2019.

(51) Int. Cl. G06F 1/16; A45C 11/00

(52) U.S. Cl. CPC G06F 1/1669; A45C 11/00; G06F 1/1654; G06F 1/169; A45C 2011/003; A45C 2011/002; A45C 2200/15; G06F 1/1677

(57) ABSTRACT

The novel innovations disclosed include a system that includes a display cover having an outside surface and an inside surface, a keyboard disposed on the inside surface, and a magnetic region extending through at least a portion of the keyboard. The system may include a retrofit magnetic adapter that includes a magnetic fastener configured to detachably couple to the magnetic region. The retrofit magnetic adapter is attachable to a display of a portable electronic device such that the magnetic fastener of the retrofit magnetic adapter is positioned along a portion of a first edge of the display.

### TECHNICAL FIELD

The present disclosure relates to enhancing, covering, protecting, and positioning portable electronic devices.

### BACKGROUND

Hundreds of millions of portable electronic devices have been sold and are in use today. One of the largest complaints from owners of these devices is their susceptibility to damage to the intricate circuitry within and to the exterior of the device principally due to the device impacting a hard surface such as when the device is accidentally dropped.

Some existing solutions to this problem that have been proposed and developed include slight variations of a cover having a four-part construction: 1) a soft felt on the interior, 2) a rigid middle layer, 3) a durable exterior with aesthetic design elements, and 4) a flexible crease or spine that connects the cover to a side edge of the portable electronic device or a side edge of a rear component that protects the back of the portable electronic device. However, some of these solutions can make portable electronic devices bulky and cumbersome to use. Others may be less cumbersome to use but fail to completely protect the devices from damage and wear. Further, some of these protective solutions may require several steps to be performed to remove them from the devices they protect, thereby resulting in an inconvenient user experience.

Some existing solutions also provide users the ability to prop up their screens at various specific angles for more convenient viewing. However, these angles are generally preset and not customizable by the users, and thus restrict how users can situate their screens. Further, some existing solutions may incorporate magnets in their cover component to allow for automatically turning on and turn off the device when opened and closed, respectively.

### SUMMARY

Novel technology for covering, protecting, and positioning portable electronic devices is described. In one innovative aspect, a system includes a display cover having an outside surface and an inside surface, a keyboard disposed on the inside surface, and a magnetic region extending through at least a portion of the keyboard. The system may include a retrofit magnetic adapter that includes a magnetic fastener configured to detachably couple to the magnetic region. The retrofit magnetic adapter is attachable to a display of a portable electronic device such that the magnetic fastener of the retrofit magnetic adapter is positioned along a portion of a first edge of the display.

It should be understood that this Summary is only illustrative and not limiting of the aspects of the technology disclosed herein, and numerous other embodiments and examples are described and encompassed hereby.

### DESCRIPTION

This application discloses innovative peripheral computing device technology. The technology may include various apparatuses, systems, methods, processes, and other aspects.

In a non-limiting example, the technology may comprise a keyboard with strategically magnetized keys or magnetized regions between the keys. The magnetic keys and/or regions around the keys are capable of magnetically attaching to a portable electronic device (e.g., phone, tablet, computer edge) to provide a sturdy prop for multiple viewing angles. Some or all of the keys, or regions therebetween, may be magnetic. For instance, one or more magnetic strips may be spaced such that they provide support for the edge of a display.

In some embodiments, the magnetic areas can overlay the keys, such that all keys are magnetic, a portion in strips, single keys, or multiple, etc. are magnetic. The magnetic areas of the keyboard may align with magnetic areas embedded in or included on a portable electronic device (e.g., a tablet computer, phone, protective case for the same, etc.)

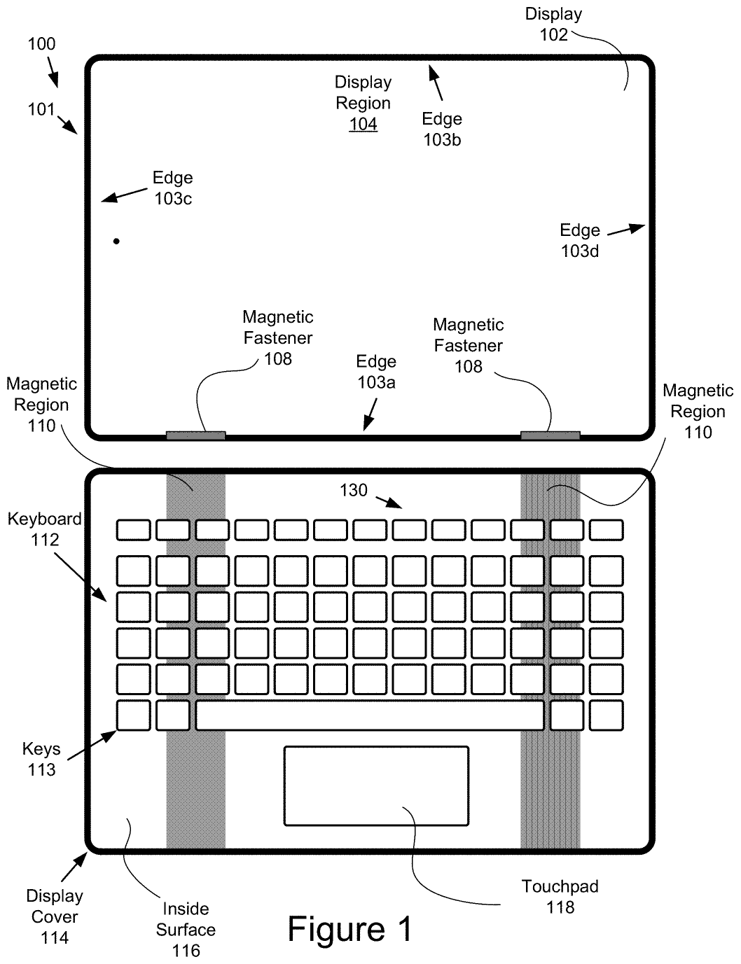

One such example system 100 is depicted in FIG. 1. As shown, a computing device display 102 may comprise a display region 104 in which a user may view content displayed in the display region 104 by the computing device 101. An example computing device 101 may include a computing tablet, such as an Apple iPad™, although it should be understood that any suitable computing device form factor may be applicable, such as a touchscreen mobile phone or another form factor. For instance, further examples may include, but are not limited to, iPad Pro™, iPad Mini™ iPhone®, etc., Samsung's Galaxy devices, etc., Amazon's Kindle™ devices, etc., etc.

As shown in FIG. 1, one or more magnetic fasteners 108 may be included on the periphery of the display. Any number of magnetic fasteners 108 may be included depending on the use case. The length, size, and/or shape of a magnetic fastener 108 may also vary. In the depicted embodiment, two magnetic fasteners 108 are included, although any suitable number (1+) may be used.

The magnetic fasteners 108 on the display 102 may be situated such that they align with corresponding magnetic regions 110 situated on a display cover 114. A magnetic region may extend along at least a portion of the display cover 114. A magnetic region 110 may be configured to couple to one or more magnetic fasteners situated along an edge of a display of a portable electronic device when situated in a viewing position. The length, size, and/or shape of a magnetic region 110 may also vary. In the depicted embodiment, two magnetic fasteners 110 are included, although any suitable number (1+) may be used.

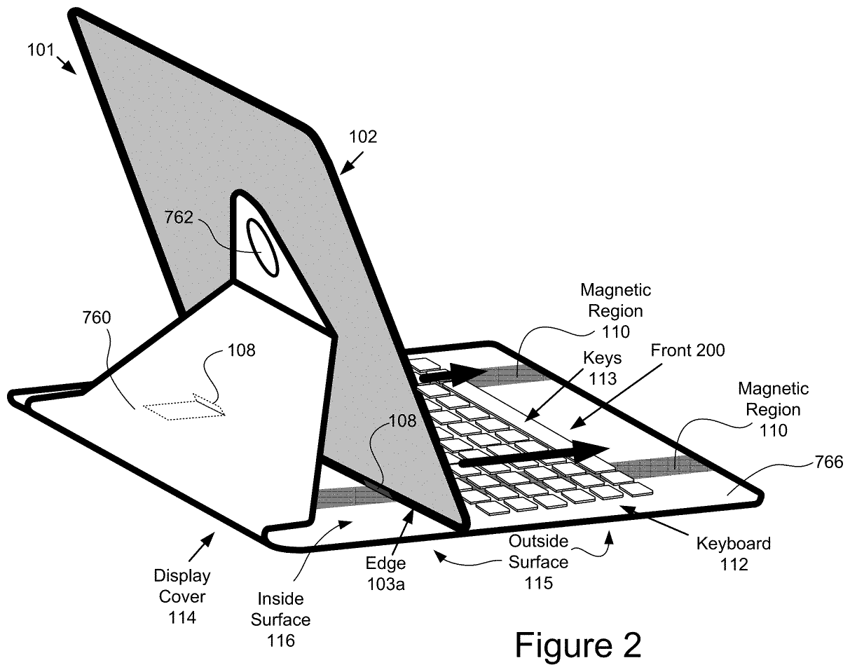

The display cover 114 has an outside surface 115 (e.g., see FIG. 2) and an inside surface 116. A keyboard 112 may be disposed on the inside surface of the display protector 766 of the display cover 114. The keyboard 112 may be attached to the inside surface 116 or formed and/or embedded in the inside surface 116, for example, although any other suitable configuration is also contemplated. In some embodiments, one or more magnetic regions 110 may extend along (e.g., though, between, aside, continuously, discontinuously, etc.) at least a portion of a keyboard 112. Advantageously, this allows the side of the display 102 on which the magnetic fasteners 110 are 108 situated to detachably couple to the display cover 114 at any suitable position along the corresponding magnetic regions 110, if with the presence of a keyboard 112, as shown in FIG. 2.

As shown in FIGS. 1 and 2, two magnetic regions 110 included in the display cover 114 extend from one side of the display cover to another side of the display cover through the keyboard 112, although if further examples they could extend along a region adjacent to the keyboard 112, from one side of the keyboard 112 to another, (e.g., top to bottom, left to right, both, a portion thereof, etc.), include or not include the keys 113 of the keyboard, etc., or have any other suitable configuration.

The display cover 114 may include a hinge or flap 760 that wraps around to the backside of the computing device 101. In some embodiments, the flap 760 may include one or more detachable fasteners that are configured to couple to the device 101. For example, the flap may be an articulating member that has a magnetic fastener configured to magnetically detachably fasten to compatible magnetic component(s) located on a backside of the portable electronic device. The compatible magnetic component(s) may be integrated into the device 101 or included in a device 101 cover, such as a protective case. For instance, the display protector portion of the display cover 114 is positionable via the flap 460 in a protective position to substantially cover a display of the portable electronic device and can be articulated to a position (referred to herein in some cases as a viewing position) underneath whatever side of the portable electronic device is facing downward. In the viewing position, the flap 760 and the display protector 766 cooperatively prop up the portable electronic device at a desired viewing angle in a portrait, landscape, etc., orientation. One advantage of attaching the flap 760 magnetically to the corresponding surface, which is also compatibly magnetic, is that the flap 760 can be rotated around relative to the surface without coming detached and/or can be slid around within the magnetic area of the surface without coming detached.

In further embodiments, the fastener 762 may be fixedly coupled to the device or an intermediate surface, such as a case surrounding the device 101. Other variations are also possible.

While continuous magnetic fastener regions 110 extending from the first side to the second side of the keyboard display cover 114 are shown in FIG. 1, it should be understood that the magnetic fastener regions 110 may be discontinuous. For example, the magnetic regions 110 may be stepped across the keyboard display cover 114 at certain periodicities allowing an edge (e.g., 103a, although 103b, 103c, or 103d could also apply in cases where the viewing position of the display 102 is configurable) of the display 102 to couple along the stepped regions. An edge 103a, 103b, 103c, or 103d may be referred to as simply 103 herein. Other variations are also possible, as further discussed herein. Regardless of the configuration, the innovative display cover configuration advantageously allows an edge (e.g., 103a) of the display to couple to the display cover 114 in a keyboard region if desired.

By way of further example, the edge 103a of a tablet screen can hold to any point on the surface where the keys are located (e.g., in single or multiple magnetic strips, entire or partial surface, via keys that are magnetic themselves, or the surface between them, or the entire surface, a combination of the foregoing, etc.).

For instance, magnetic fastener(s) 110 can be fastened to a magnetic region 110 between two or more keys 113 of the keyboard 112, one or more keys 113 of the keyboard 112 may be magnetized and comprise a portion of a magnetic region 110, one or more magnetic fasteners 110 can be fastened to the one or more keys 113, one or more keys 113 of the keyboard 112 can be magnetized and comprise a portion of the magnetic region 110, and/or a touchpad 118 of the keyboard 112 may be magnetized and comprise a portion of the magnetic region 110.

FIG. 2 depicts an example of the display 102 being tilted on the bottom edge 103a towards the front 200 of the keyboard 112 embedded in the display cover 114. As shown, the magnetic fasteners 108 of the display 108 may be slid along the corresponding magnetic regions 110 of the display cover 114 even such that the bottom edge of the display screen may be situated on top of the keyboard 112 or between the keys 113.

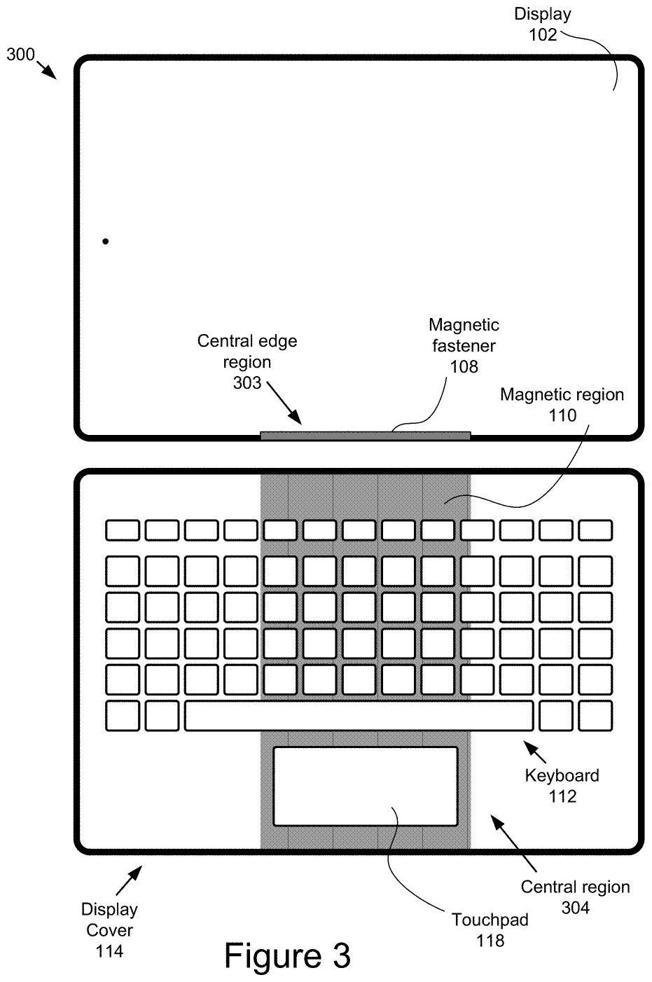

FIG. 3 depicts a configuration 300 where a single magnetic fastener 108 included in a central region of the edge 303 of the display 102 and a corresponding magnetic fastener 110 is depicted as extending along a central region 304 of the display cover 114 in a middle area of the keyboard 112 and/or touchpad 118.

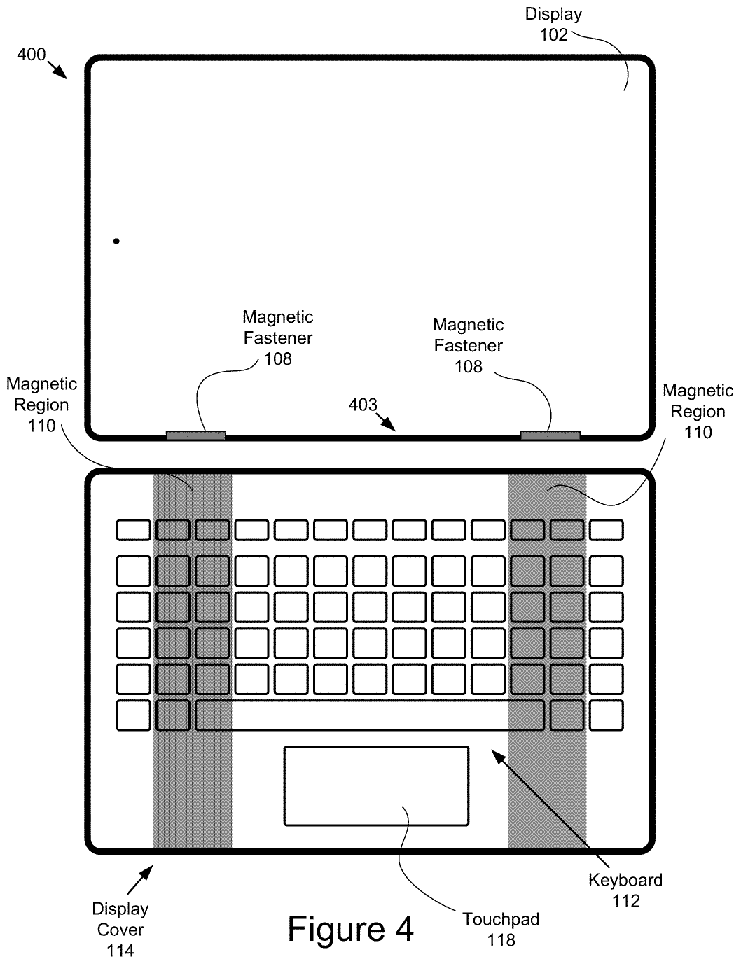

FIG. 4 depicts a configuration 400 where some keys 113 of the keyboard are magnetic as reflected by the shading, either because they are magnetic themselves or areas under the keys 113 and/or touchpad 118 are sufficiently magnetic to couple to the magnetic fasteners 108. This advantageously allows the user to slide and/or tilt the display 102 at any desirable angle regardless of whether the bottom edge 403 of the display 102 is situated between or on top of any keyboard key(s) 113 and/or the touchpad 118.

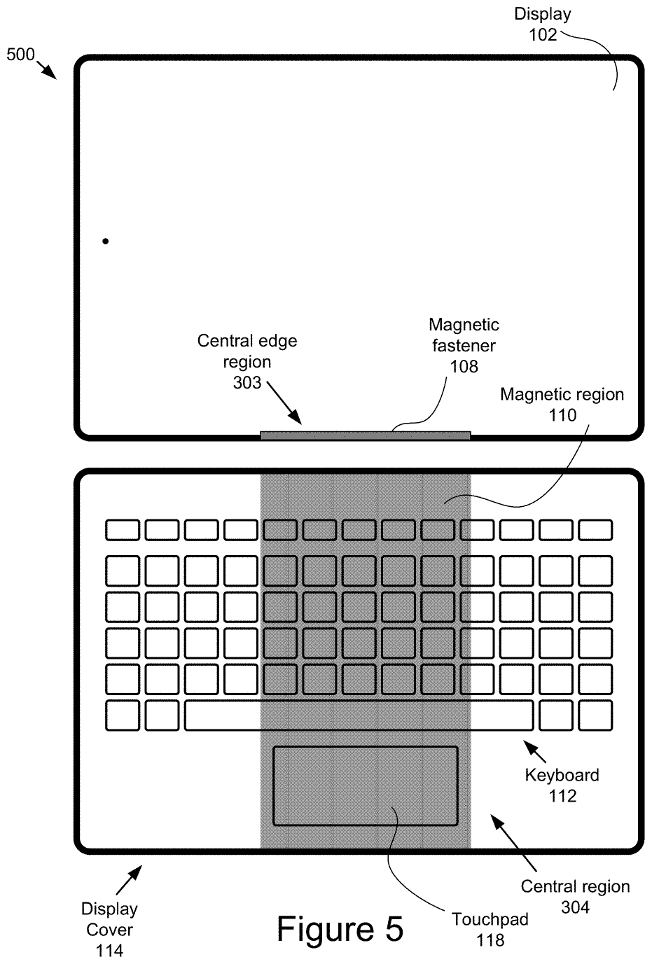

Similarly, in FIG. 5, the configuration 500 includes a central magnetic region 110 that may comprise magnetic keys 113 and/or touchpad 118, either by being magnetic themselves, having magnetic areas(s) (e.g., films, material, etc.) disposed under or over the keys and/or touchpad strong enough to not be inhibited by the presence of the keys, etc. The corresponding central magnetic fastener 108 of the display 102 can couple at any point along the magnetic region 110, even if situated on the keys 113 of the keyboard 112 and/or the touchpad 118.

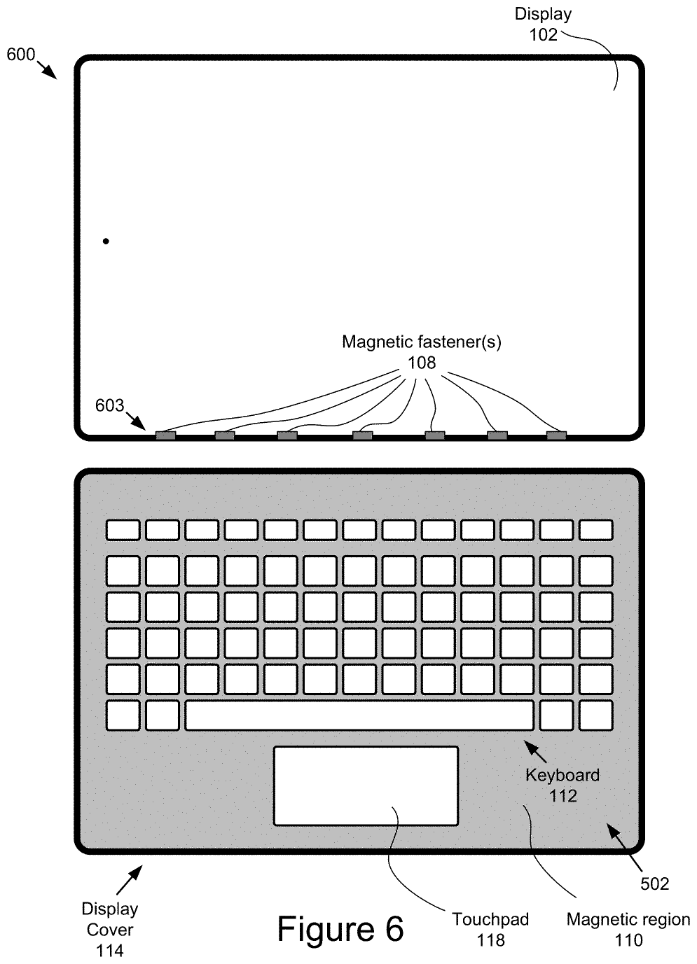

FIG. 6 depicts a further configuration 600 in which the area 502 surrounding the keys in the keyboard and the touchpad is magnetic and comprises a magnetic region 110, and one or more corresponding magnetic fasteners 108 are included along the edge 603 of the display 102 and are capable of detachably coupling to any desirable points in the magnetic area 502 of the display cover 114. In a further example, the magnetic fastener(s) 108 may take other forms. For example, a single magnetic faster 108 may extend along all or substantially of the edge 603, fewer but longer magnetic fasteners 108 may be used, etc.

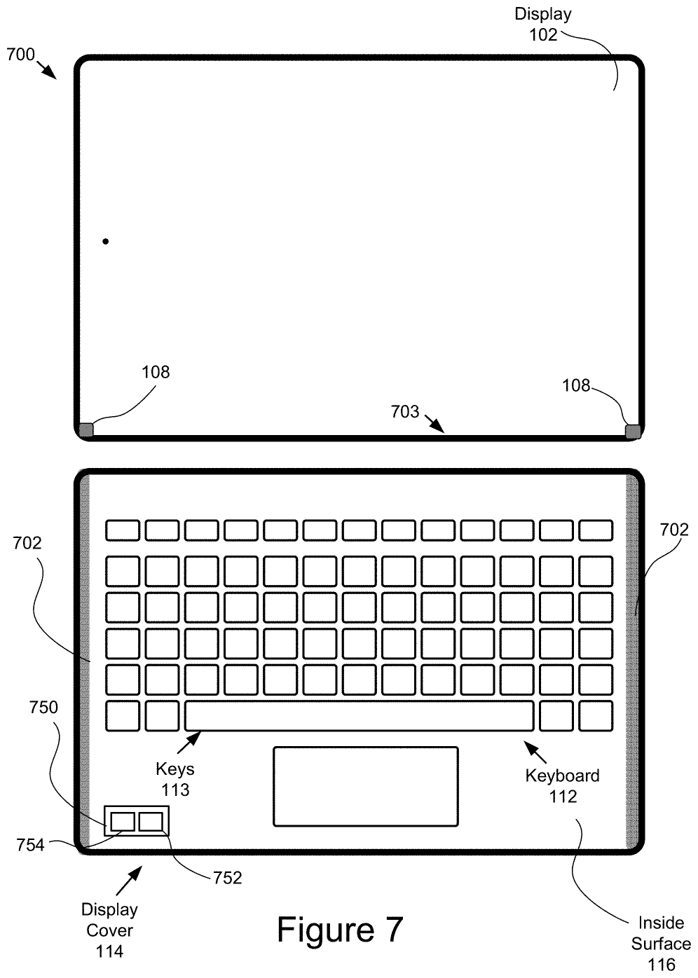

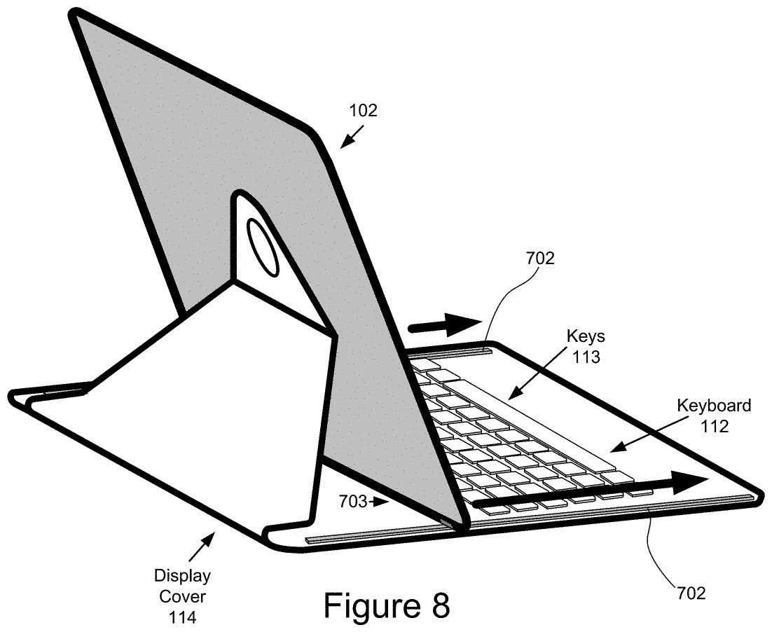

FIG. 7 depicts a configuration 700 where magnetic raised areas (e.g., rails, edges, etc.) 702, which act as magnetic regions 110, are included in or on the display cover 114 inside surface 116. The display 102 includes corresponding magnetic fasteners that are configured to detachably couple to the raised areas 702 of the display cover 114. As shown in FIG. 8, this advantageously allows the display 102 to be situated at any point along the raised edges 702 without impedance from the keys 113 of the keyboard 112 because the raised edges 702 space the edge 703 of the display 102 above the top surfaces of the keys 113.

By way of further example, the embodiment depicted in FIG. 7 is advantageous as it can prevent the screen edge 703 from inadvertently “pressing” the keys by providing a bridge via the raised areas 702. In the depicted example, the bridge might be supported on the raised area(s) 702, although other configurations may have singular or multiple channels that run through the keyboard 112 area. In these examples, the display 102 can easily slide along this raised area 702 instead of the keys 113 themselves. In some cases, the edge of the display 102 could be just above the surface of the keys 113 so as not to overly protrude. In some cases, the raised regions 702 may comprise the magnetic regions 110, and in other cases, the raised areas 702 may be used in combination with other magnetic region(s), such as those discussed herein, to couple the edge 703 to the display cover 114.

In some cases, when a screen edge 103 slides to cover some of the keys 113 and/or is on top of some of the keys 113, the technology described herein may be configured to signal to the keyboard electronics to power off the keyboard 112, and when the edge 103 slides to an area above, below it, or is otherwise removed, the electronics may be configured to power on the keyboard 112.

In some embodiments, the display cover 114 may include such electronics, which may be configured to electronically couple the keyboard to the computing device 101, control the keyboard, and supply power. For example, the display cover 114 may include a computing unit 750 comprising a processor/controller 754 and one or more sensors 752. Other suitable components may also be included in the computing unit 750 and coupled to the processing unit 754 and sensor(s) 752, such as a power supply (e.g., battery, charging unit, etc.), non-transitory memory, input or output devices (e.g., buttons, LEDs, etc.), etc.

The controller 754 is electronically coupled to the sensor(s) 752 to send and receive electronic signals. One example sensor 752 may be configured to wirelessly or wiredly communicate with the computing device 104 and/or a computer network (e.g., the Internet, etc.). Another example sensor 752 may be configured to detect a position of an edge of a display 102 of a portable electronic device 101, and the controller may be coupled to the sensor and configured to activate and deactivate the keyboard based on signals received from the sensor. For example, the sensor 752 may be a proximity sensor that detects the position of the display 102 (e.g., tilt angle, position of the lower edge of the display 102, etc.). In another example, the sensor 752 may be a capacitive touch sensor, weight sensor, or another contact-based sensor. In another example, the sensor 752 may be a light-based sensor. In another example, the device 101 may communicate data reflecting the position of the display 102, such as a single from a gyroscope of the device 101, etc., to a transceiver of the display cover 114, which may communicate the signals to the controller 754. It should be understood that any type of sensor capable of detecting a position of the display 102 is contemplated and encompassed hereby.

Responsive to receiving one or more signals from the sensor(s) 752, the controller 754 may activate or deactivate the keyboard 112. For example, upon detecting, based on the proximity, touch-based, light-based, or other signals that an edge of the display 102 is resting on the key(s) 113 of the keyboard 112, the controller 754 may deactivate the keyboard 112 to prevent inadvertent key presses. Then, once the controller 754 detects, based on further such signals, that the edge of the display 102 has been moved off of the key(s) 113, the controller 754 may reactivate the keyboard 112.

In yet another example, if an entire row of keys 113, or several keys 113 (e.g., 4 or more) in the same row, register to the controller that they are being simultaneously pressed, the controller 754 may determine that an edge of the display 102 is resting on the keys 113 and deactivate the keyboard, and may reactivate the keyboard once the controller 754 detects that the keys have been released. In this example, the keys 113 themselves act as a sensor 752.

In some embodiments, the area 130 above the keys may be magnetic also to hold a finite area of micro angle adjustments for when the keyboard is in use, such as where the screen would be propped while in “typing mode”. Alternatively, when the screen/display 102 is transitioned to the space below this area and directly above any of the keys, it could be considered to be in “non-typing mode” for unlimited viewing angles.

In FIGS. 1-7, the magnetic fasters 108 of the display 102 may be included in a display cover attached to the display 102, such as the display cover described in U.S. Pat. No. 9,131,756, which is incorporated by reference herein in its entirety, or in the display 102 itself. Alternatively, retrofit attachments, also called adapters, may be used to attach the magnetic fasteners 108 to the display 102.

In some implementations, a retrofit attachment may include at least one magnetic fastener 108 and an attachment mechanism. The attachment mechanism may include (e.g., be connected to, incorporate, be integral with, etc.) the magnetic fastener(s) 108 and be configured to attach to a display 102 of a portable electronic device 101 such that the magnetic fastener(s) 108 are positioned along a portion of a lower edge of the display 102. For instance, clips, grippers, adhesive members, or other attachments may attach to the edge(s) of the display 102. These attachments could include and/or house the magnet fasteners 108 that are capable of coupling to the keyboard display cover 114. In a further example, the attachment(s) could be magnetic sticker(s) that could be applied to the edge(s) and/or back of the display 102.

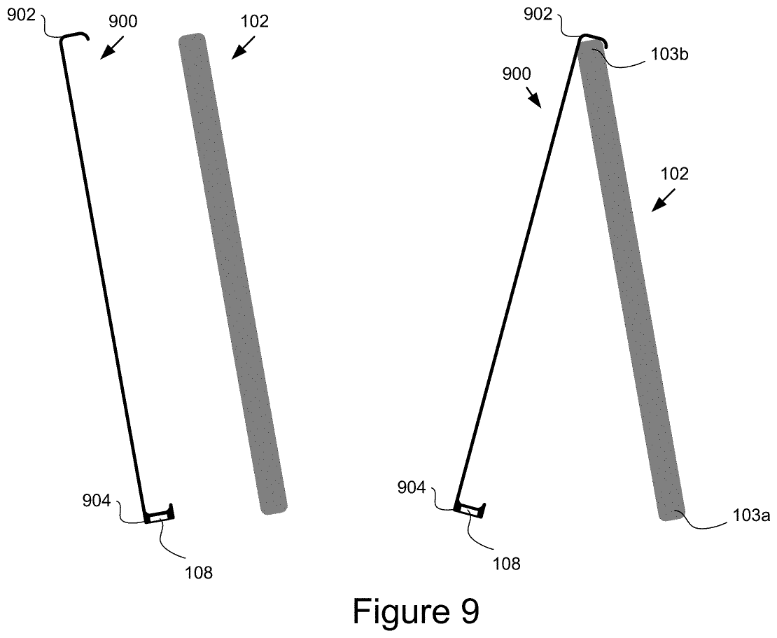

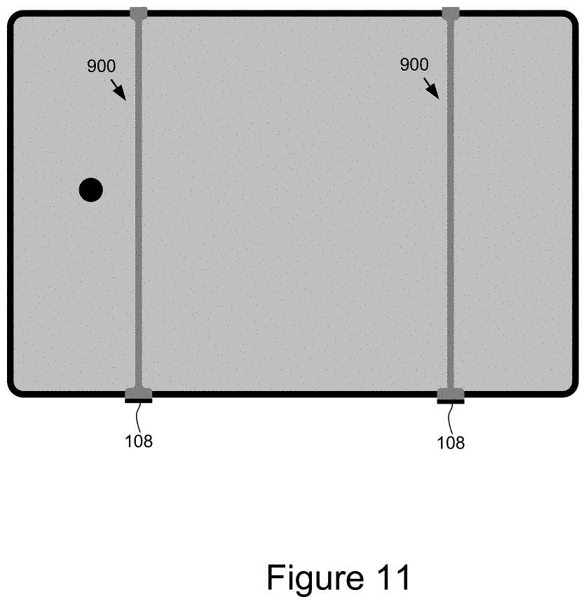

FIGS. 9-11 collectively depict an example display magnet apparatus 900, which is also referred to herein as a retrofit magnetic adapter. The apparatus 900 may comprise a clip that may be applied to a display 102 to provide the display 102 with one or more magnetic fasteners 108 along an edge region so the display 102 can be used with the various display covers 114 described herein. As shown, apparatus 102 may include a second end 902 (e.g., comprising a display attachment device 907), a connector 903 that connects the second end 902 and a first end 904. The first end 904 (e.g., comprising a display attachment device 908) may include one or more magnetic fasteners 108.

The first display attachment device 908 of the first end 904 may be configured to clip/grab and retain/hold a first edge 103a of the display device 102, and the second display attachment device 907 of the second end 902 may be configured to clip/grab and retain/hold a second edge 103b of the display device 102.

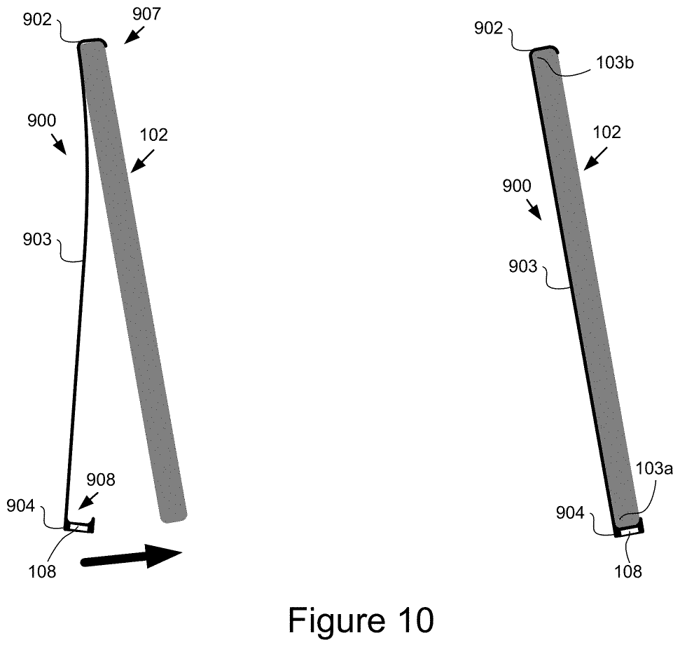

The connector 903 connecting the first and second display attachment devices 908 and 907/ends 904 and 902 may be configured to be flexible so that the display magnet apparatus 900 may be applied easily, conveniently, and securely by a user to the display 102. For example, the connector 903 may be bendable (in some embodiments reversibly so it doesn't permanently deform when applied) and configured to be flexed for application to the display. For instance, as depicted in FIG. 10, the second end 902 may be placed on the second edge 907 of the display device 102 and pulled to apply pressure. The first end 904 may be bent outward while applying the pressure to retain the second end 902 to the second edge 103b and then moved inwardly to fit around the first edge 103a of the display 102, as shown in FIG. 10. The apparatuses 900 may be applied anywhere along the display 102 to situate the magnetic fasteners 108 in the appropriate places such that they correspond with the magnetic regions 110 of the display cover 114.

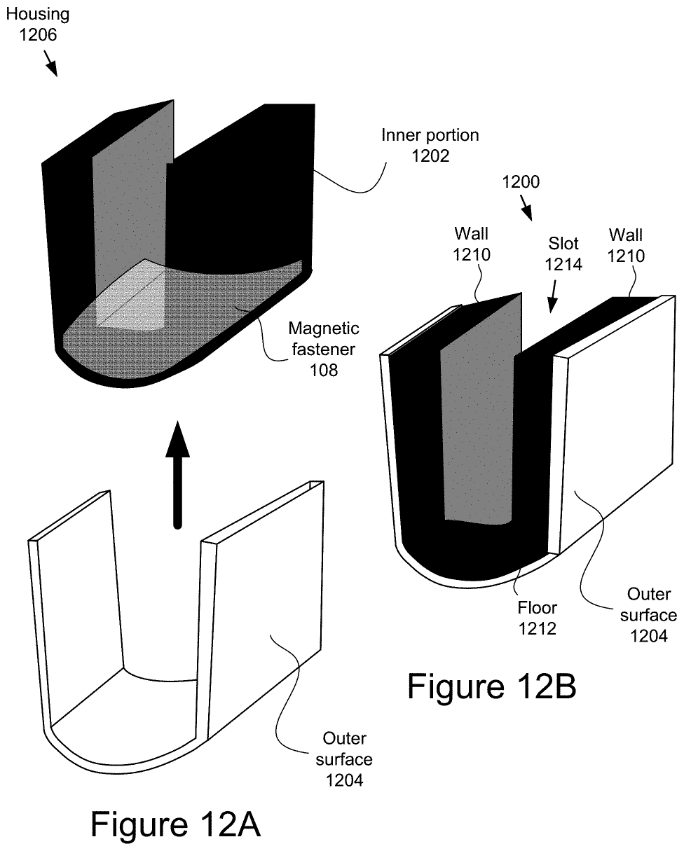

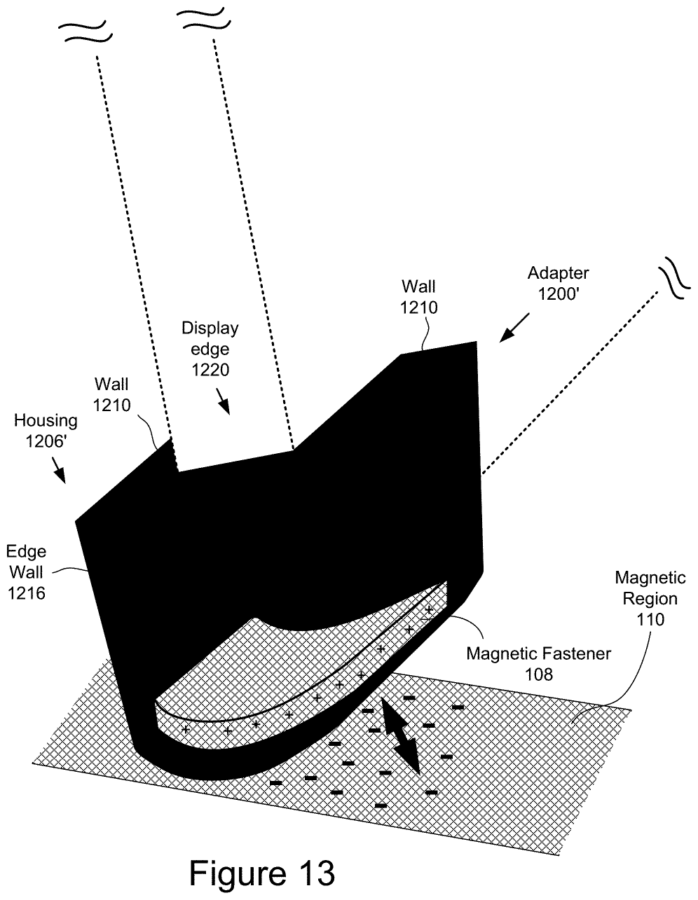

FIGS. 12A-15 depicted another embodiment of a retrofit magnetic adapter 1200. In this embodiment, the adapter 1200 is a u-shaped magnetic fastener apparatus that can be applied to an edge region of the display 102. As shown, the adapter 1200 has a u-shaped housing that contains one or more magnetic fastener(s) 108 in the floor portion 1212 connecting the two sides/walls 1210 of the housing. The floor 1212 may house the magnetic fastener. The slot/cavity 1214 formed by the sides 1210 of the housing 1206 can attached to (e.g., receive and removably grip) an edge or corner of the display device 102. This allows the adapter 1200 to securely stay on the display 102 during use and to be removed when needed. The magnetic fastener(s) 108 included in the apparatus 1200 may be positioned such that they magnetically couple to the corresponding fasteners/fastening regions in the display cover 102, as shown in FIG. 13.

In an example, the housing 1206 may include an inner portion 1202, such as a rubber component, with an embedded magnet, and an outer shell 1204 that encases the inner portion 1202, although other variations in terms of materials and configurations are possible. For example, the inner portion 1202 and the outer shell/surface 1204 may be combined as a single component, or make have further layers or sub-components.

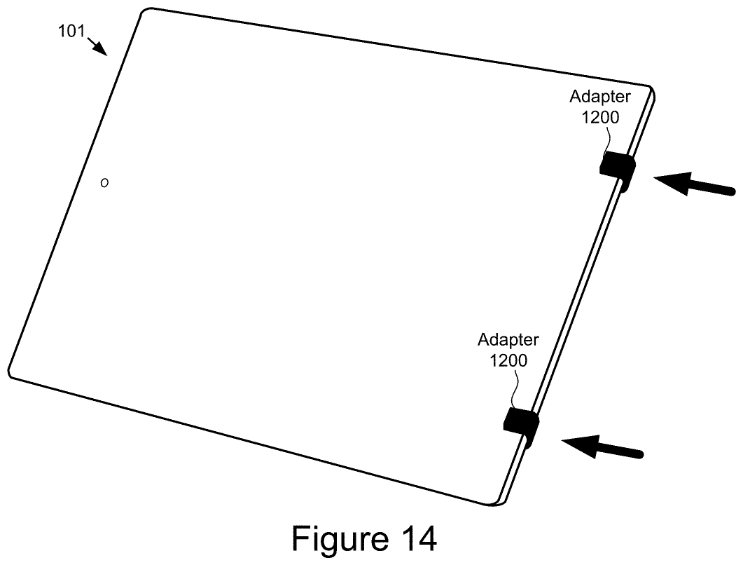

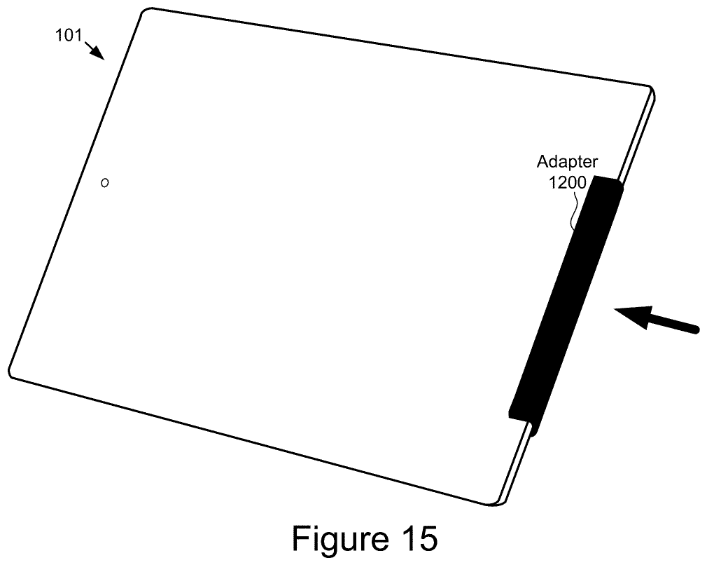

In an example, the inner portion 1202 may comprise a rubber component or other suitable grippy material (e.g., synthetic membrane, cork, silicon, etc.) that is pliable and/or stretchable as it slides onto the edge of the display with the necessary memory tension to hold it in place. The adapter 1200 could attach/clip onto any edge of the display and be shorter or longer in length depending on the configuration, as shown in FIGS. 14 and 15. The adapter can also be flexibly placed (e.g., at a corner, anywhere along an edge region, such as anywhere along the edge of the tablet or phone, etc. For example, FIG. 13 depicts a further configuration 1200′ of the adapter 1200 which includes an alternative housing 1206′ where one side of the slot is closed by an edge wall 1216 so the adapter can slide onto and abut to a corner 1220 of the display 102. As shown, the magnetic fastener 108 is configured to couple to the magnetic region 110.

In some embodiments, in addition to retrofit devices, such as a case that attaches to the display that includes the magnetic fasteners 108 of the display and/or apparatuses comprising the clips as shown and described, the magnetic fasteners 108 may be integrated into the display itself (e.g., embedded in the tablet, etc.).

The magnetic materials (e.g., 108, 110, 762, etc.) discussed herein mean ferromagnetic metal, a ferromagnetic material, or any similar materials exhibiting magnet-like properties. However, it should be understood that other equivalent fasteners could be used, such as hook/loop, friction, micro-suction, non-slide material, etc.

The elasticity of the material(s) used in the apparatuses 900, 1200, 1200′, etc., and/or any variations thereof may vary depending on the material used and/or the application for the apparatus. For instance, a particular material having a particular Young's modulus may be selected for a given application depending on the aggressiveness of that application in terms of the device being equipped, the amount of use and force to be used during operation of the device 101, etc. Non-limiting example materials that may be used include thermoplastics, nylon, wood or other similar natural materials, other suitable synthetic materials, steel, aluminum, other suitable metals, 3D printable materials, etc.

The foregoing description, for purpose of explanation, has been described with reference to various embodiments and examples. However, the illustrative discussions above are not intended to be exhaustive or to limit the invention to the precise forms disclosed. Many modifications and variations are possible in view of the above teachings. The various embodiments and examples were chosen and described in order to best explain the principles of the invention and its practical applications, to thereby enable others skilled in the art to utilize the innovative technology with various modifications as may be suited to the particular use contemplated.

What is claimed is:

1. A display protection system, comprising:
a display cover having an outside surface and an inside surface;
a keyboard disposed on the inside surface; and
a magnetic region extending along at least a portion of the keyboard.

2. The display protection system of claim 1, further comprising:
a sensor configured to detect a position of an edge of a display of a portable electronic device; and
a controller coupled to the sensor, the controller configured to activate and deactivate the keyboard based on signals received from the sensor.

3. The display protection system of claim 1, wherein:
the display cover includes a flap that is fastenable to a surface located on a backside of a portable electronic device.

4. The display protection system of claim 2, wherein:
the magnetic region is configured to couple to one or more magnetic fasteners situated along an edge of a display of a portable electronic device when situated in a viewing position.

5. The display protection system of claim 3, wherein:
the one or more magnetic fasteners are fastenable to the magnetic region between two or more keys of the keyboard.

6. The display protection system of claim 3, wherein:
one or more keys of the keyboard are magnetized and comprise a portion of the magnetic region; and
the one or more magnetic fasteners are fastenable to the one or more keys.

7. The display protection system of claim 1, wherein:
one or more keys of the keyboard are magnetized and comprise a portion of the magnetic region; and/or
a touchpad of the keyboard is magnetized and comprises a portion of the magnetic region.

8. The display protection system of claim 1, further comprising:
a retrofit magnetic adapter that includes a magnetic fastener configured to detachably couple to the magnetic region, the retrofit magnetic adapter being attachable to a display of a portable electronic device such that the magnetic fastener of the retrofit magnetic adapter is positioned along a portion of a first edge of the display.

9. The display protection system of claim 7, wherein the retrofit magnetic adapter further includes:
a clip including a first end, a second end, and a connector connecting the first end and the second end, the clip configured to clip to the first edge of the display at the first end of the clip and a second edge of the electronic device at the second end of the clip.

10. The display protection system of claim 7, wherein the retrofit magnetic adapter further includes:
a housing including:
a slot for receiving and removably gripping to the first edge of the display; and
the magnetic fastener.

11. The display protection system of claim 7, wherein the housing includes a first wall, a second wall, and a floor, the floor connecting the first wall and the second wall, the first wall, the second wall, and the floor forming the slot, and the floor housing the magnetic fastener.

12. The display protection system of claim 1, further comprising:
a retrofit magnetic adapter that is configured to attach to a corner of a display of a portable electronic device.

13. A display magnet apparatus comprising:
a magnetic fastener; and
an attachment mechanism including the magnetic fastener and configured to attach to a display of a portable electronic device such that the magnetic fastener is positioned along a portion of a first edge of the display.

14. The display magnet apparatus of claim 13, wherein the attachment mechanism comprises a clip including a first end, a second end, and a connector connecting the first end and the second end, the clip configured to clip to the first edge of the display at the first end of the clip and a second edge of the electronic device at the second end of the clip.

15. The display magnet apparatus of claim 14, wherein the connector is reversibly bendable and configured to be flexed for application to the display.

16. The display magnet apparatus of claim 13, wherein the retrofit magnetic adapter further includes:
a housing including:
a slot for receiving and removably gripping to the first edge of the display; and
the magnetic fastener.

17. The display magnet apparatus of claim 13, wherein the housing includes a first wall, a second wall, and a floor, the floor connecting the first wall and the second wall, the first wall, the second wall, and the floor forming the slot, and the floor housing the magnetic fastener.

18. The display magnet apparatus of claim 13, further comprising:
a retrofit magnetic adapter that is configured to attach to a corner of a display of a portable electronic device.

19. The display magnet apparatus of claim 13, further comprising:
the magnetic fastener is configured to detachably couple to a magnetic region extending through at least a portion of a keyboard of a display cover.
